(19) United States
(12) Patent Application Publication
(10) Pub. No.: US 2010/0089052 A1
(43) Pub. Date: Apr. 15, 2010

(54) POWER MACHINERY OF WAVES

(76) Inventor: Bjoern Rothausen, Copenhagen (DK)

Correspondence Address: Rothausen, Bjoern, Refshalevej 200 Z, Copenhagen, DK 1432 K, DK

(21) Appl. No.: 12/310,347

(22) PCT Filed: Nov. 20, 2007
(86) PCT No.: PCT/DK2007/000508

§ 371 Date: Dec. 11, 2009

(30) Foreign Application Priority Data
Nov. 28, 2006 (DK) PA 2006 01599

(51) Int. Cl. F03B 13/18

(52) U.S. Cl. 60/497

(57) ABSTRACT

Method for getting of an optimum drift of a power machine of waves, where the arrangement or the apparatus consist of one or more upright standing legs (11 and 8) with an integrated arrangement of piston (10) for transmitting of energy. The rod of the piston (10 A) in the integrated arrangement of piston (10) is loosed or free placed on the bottom of the sea (17). The cylinder (8) for this is mounted on a float (14), where the energy which has to be obtained from this, and has to be produced in the legs (11 and 8), by and in the cycle of working. Namely in the down going stroke of the power machinery of waves. The cycle of working for getting of the most optimum energy by the arrangement has to be established by a raising of sucking in pressure, by help of a pressure, which has to be accumulated in the belonging tanks (12) to the power machinery of waves. The accumulated pressure has to be made of the stroke of the energy producing cylinder (10 and 8).

### THE FIELD OF THE APPLICATION OF THE INVENTION

The invention concern a method for making an optimal working of a power machinery of waves.—Where the machinery or the apparatus consist of one or more upright standing legs, with an integrated arrangement of pistons for transmission energy.

### KNOWN TECHNOLOGY

Hitherto is known power machinery of waves, as an example described according to the French document of patent no. FR 2607870 A1, where this machinery has an upright standing leg, and where the leg in the same time is a cylinder with a piston, and where the arrangement of piston via a floating arrangement transmit the movements of the surfaces of the sea, both for the up-going as the down going movement for a hydraulic pressure via more arrangements of valves.

The disadvantages by this arrangement is that one usually use the up-going movement of the floating as power source, which is opposite the direction of the force of the gravity, why the own weight of the floater in some grade, and the hydraulic power take-off in specially grade limit the possibility of the floater for lift, and by this, the size of the power take-off.

### THE TECHNICAL PROBLEMS, WHICH SHALL BE LOOSED

By the invention one want to procure a power machinery of waves with up-standing legs, and with, in this, integrated pressure cylinders and pistons of the mentioned sort, where one with a new method of working, and an apparatus for this, now transmit and pick up a greater part of the coming power of waves to the arrangement.

### The New Technique

The new is that the energy, which has to be produced, is produced in the legs, by and in the down-going stroke of the power machinery of waves.

The own weight of the float and the force of the gravity can very easy defeat the resistance from the tapping means of the hydraulic power, why this do not have any influence at all.

In the stroke of the suction, in the up-going movement of the waves, the heighten pressure of sucking in, make a pressure on the piston of the cylinder, which of course have a bottom contact. And the counter pressure will therefore lift the float, because the cylinder is mounted on or at to the float.

The float get in such a way help in its up-going movement, and it will moreover get, according to the pressure, a higher energy of level position.

### The New Technique

The new is also, that there in one working operation for making or getting power energy by the arrangement has to be establish a heighten pressure of sucking in, which has to be accumulated in the belonging tanks for the power machinery of waves. And where the accumulated pressure itself has to be made of the energy producing stroke of the cylinder.

One obtain by this that the arrangement establish a heighten sucking in pressure qua the accumulated pressure, which has to be made of the energy producing stroke of the cylinder.

### The New Technique

The new is also that the piston rod in the integrated piston arrangement is placed freely or loose on the bottom of the sea, and where the cylinder itself, and for this, is mounted on a float, and where the piston rod in this combination works as counter hold leg. As there at the end of the piston rod against the bottom is mounted a movable and yielding presser foot or a ski, which in its plan of foot—or ski continuous follow the surface of the bottom of the sea.

One obtain by this that the presser foot get an optimum supporting and counter holding for its pumping function via the arrangement of the piston in the leg.

### The New Technique

The new is further that the vertical standing leg with the integrated arrangement of piston is equipped with a glide—and couple pipe for coupling and guiding of the lower part, as the upper part, of the vertical standing leg, for a continuous contact and a counter hold against the bottom, and by this a functional contact for it now working arrangement of piston.

One obtain by this that the counter hold system as the pumping system has to be coupled infinitely gliding together, in such a way that the distance between them can be extended or shorted. But where one still get the proportions and the conditions for an optimum pump function.

### FIGURE LIST

The invention shall after this be explained nearer according to reference of the drawing, where

FIG. 1 shows a vertical cut of a vertical standing leg, here mentioned as counter hold leg, with an integrated arrangement of pistons for transmitting of energy for the actually arrangement of power machinery of waves, which is placed for production of energy out on the sea.

FIG. 2 Shows a vertical cut of a vertical standing leg, with pressure boilers for fill up a pressure via the stroke up and down of the movement of the waves, and where there here are shown the stroke of the sucking in.

FIG. 3 shows in a vertical cut a vertical standing leg with pressure boilers for fill up via the stroke up and down of the movement of the waves, and where there here are shown the stroke of compression.

### EXAMPLE OF EMBODIMENTS

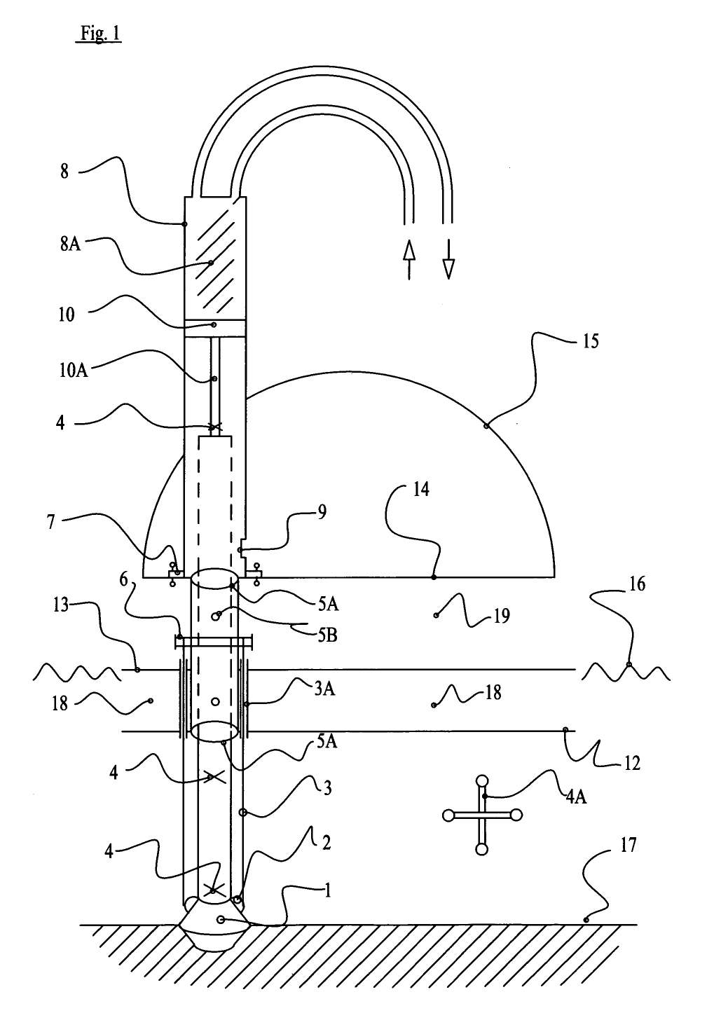

FIG. 1 shows in a vertical cut a vertical standing leg 11 and 8, here named as counter hold legs 11 and 8, with an integrated arrangement of piston 10 for transmitting of energy for the actually arrangement of power machinery of waves, which is placed for production of energy out on the sea.

The leg itself 11 and 8, here named as the counter hold leg 11 and 8 consist of two parts, namely a under water part 11, named as the under water leg 11, and a upper water part 8, named as the hydraulic cylinder 8.

The under water leg 11 is limbered up by pressure strong cardan joint 4, made of strong material, and with strong bearing sleeves 4A, which is welded for a fixing.

The underwater leg 11 has a double conical step foot 1 with haul up—wire-eyes 2 for up hauling wires 3.

The under water leg 11 is guided through the float in the sliding pipe 5. The upper water part/the hydraulic cylinder 8 consist of cylinder 8, with piston 10 and a piston rod 10A. The cylinder 8, which has ventilation hole 9, is mounted 7 to the deck 14. The ventilation hole 9 prevent vacuum and compress in the cylinder 8 under the piston 10. Under the installation the under water leg 11 has to be bolted together with the piston rod 10A, by which the piston 10 get contact with the bottom of the sea 17

The counter hold leg is loose standing on the bottom of the sea 17.

The sliding pipe 5 is going through the float and is fixed mounted to this.

The sliding pipe 5 has welded up pulled pipes 3A, and mounted wire up pulled winch 6, which regulate the extract of the under water leg 11.

The sliding pipe 5 has sliding end bearings 5A, which have to be greased from grease nipples 5B.

Of more components to the power craft machinery of waves according to FIG. 1 can be mentioned the bottom of the float 12, the deck of the machinery room 13, the machinery room 19, water ballast room 18 and the surface of the sea itself 16.

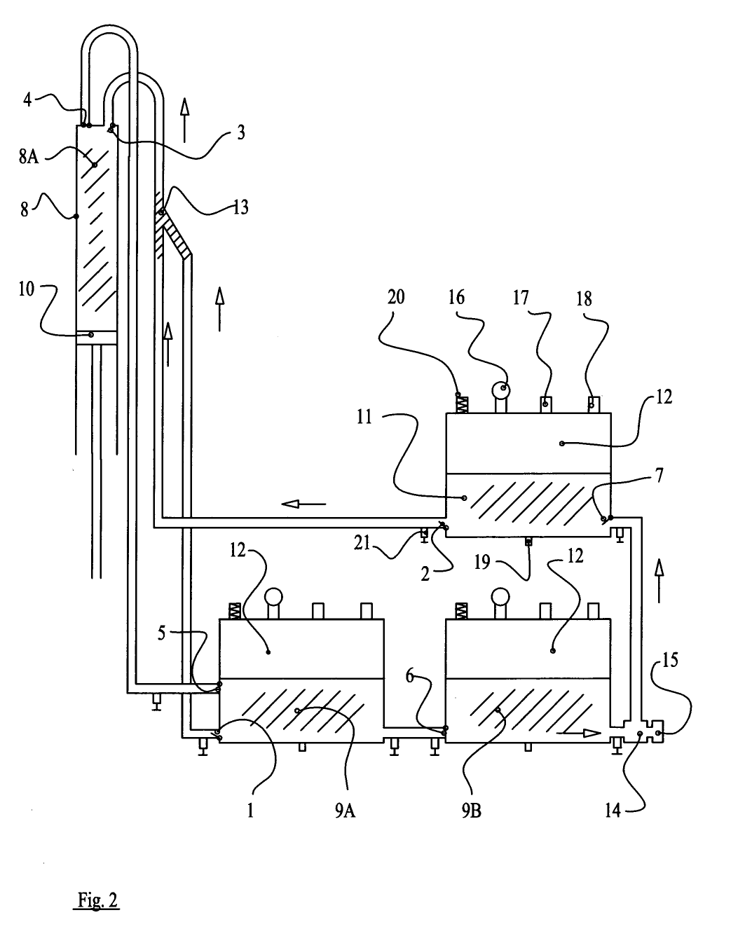

FIG. 2 shows in a vertical cut an upright standing leg 11 and 8, with pressure tanks or boilers 12 for getting the press via stroke up and down of the movement of the waves, where there here are shown the stroke of sucking in by a higher loading pressure.

In the up going movement of the waves the volume of the cylinder 8A has to be raised over the standing still piston 10, because the float with the mounted cylinder 8 has to move up.

Because of that there are getting a different of pressure, which automatically open the one way valves 1, 2 and 3 and automatically close/stop the passing through from the one way valves 4, 5 and 8.

The loading pressure of the stroke of the sucking in is the throttle control of the float, because the size of the production is depend of this.

The loading pressure are secured the contact of the counter hold leg to the bottom of the sea.

The loading pressure has to be regulated by using of manometer 16, the means of air pressure supplying 17, the regulating screw of the pressure 18 and drain cock 19.

Position 20 is a safety valve. The loading pressure has to be established by larger quantity of hydraulic oil from the lover pressure tank 11. And with this a lesser, but a pressure giving lot of oil from the high pressure tank 9A.

The quantity of oil has to be regulated by an adjustable closing cock 21. The oil stream has to be gathered in a lead 13 of 3-way-coupling.

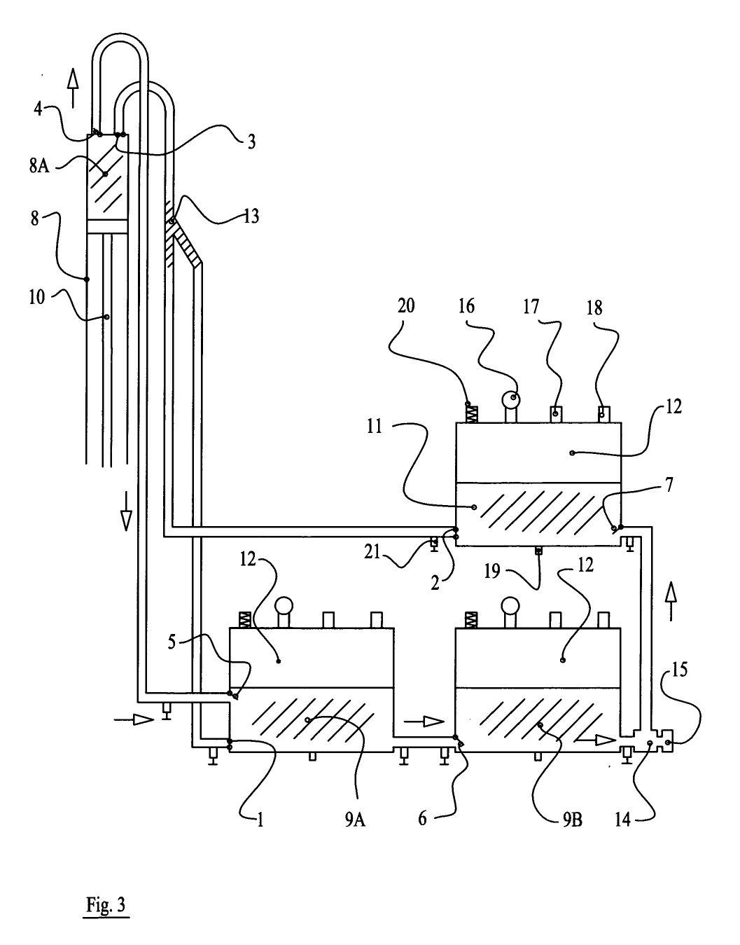

FIG. 3 shows in a vertical cut a vertical standing leg 11 and 8 with pressure tanks 12 for getting press via the stroke of the movement of the waves up and down, where there here are shown the compression stroke for down going movement of the waves.

The volume of the cylinder 8A over the standing still piston 10 has to be reduced, because the float with the mounted cylinder 8 move down.

Because of that arise there a different of pressure, which cause automatically opening of the one way valves 4, 5 and 6, and automatically closing or stop of the passing through from the one way valves 1, 2 and 3.

The energy tapping has by this to be transmitted to the high pressure tanks 9A and 9B, by which the air mass/air pillow has to be pressed together.

The pressed air pillow 12 accumulate the pressure energy for use for a smooth pressure of oil to the hydraulic engine 14 and generator 15, which produce electricity.

### SUPPLYING REMARKS FOR EXAMPLES OF EMBODIMENTS

The arrangement of power machinery of waves is mounted on a float of the type “point-absorber”, and have to be placed on open sea with slack mooring.

The weight of the float is adjustable with the water ballast in tanks.

The float produce electricity from power of waves by taken out of energy i the down going movement of waves, where the own weight of the float and the size of the wave is factors in the account of energy (power×way).

The tapping of power has to be done by free on the sea bottom standing counter hold leg, guided through the gliding pipe of the float, and following bolted together with the rod of the cylinder piston.

The hydraulic cylinder is a single working, with a hole of ventilation in the lower part, and it will be mounted to the float.

The under water part of the counter hold leg is done ductile by strong cardan parts, made of strength material.

The under water part has tread foot, double conical made, and with hauling up eyes for hauling up wires.

The gliding pipe is mounted on the float, and consist of a strong pip with greased end sleeve bearings, and have welded on, up hauled pips for up hailed wires.

Capstans will regulate the length of the extraction of the counter hold leg.

The hydraulic system of the float consist of: Hydraulic cylinders, high pressure tanks, low pressure tanks, hydraulic engine and generator.

The pressure tanks have air mass/air pillow, which under the power taken out will be pressed of the hydraulic pressure, and by this accumulate the power of the pressure for use for an easy and regulating power supplying to the hydraulic engine and the generator.

The pressure tanks is equipped with: Manometer, safe valves, adjustable closing valves for all connections of pipes to/from the pressure tanks, water draining valve, means for receiving of air pressure and air screw for regulation of air pressure. The raised charging pressure has to be done of a larger lot of hydraulic oil from the low pressure tank I, and a lesser lot of pressure giving hydraulic oil from high pressure tank 9A, gathered in a 3-way connection of pipe to the hydraulic cylinders.

In the cycle of operation itself is it the float, and one to the float mounted cylinder, which working up and down, around the constant standing still piston with contact of the sea bottom.

The arrangement has to be started up via the pressure tanks (air pressure).

1. Method to get an optimum drift of a power machinery of waves, where the arrangement or the apparatus consist of one or more upright standing legs (11 and 8) with an integrated arrangement of piston (10) for transmitting of energy, characteristic of, that the energy, which has to be extraction from here, has to be produce in the legs (11 and 8), by and in the cycle of operation, namely in the down going stroke of the power machinery of waves.

2. Method to get an optimum drift of a power machinery of waves, where this consist of one or more legs (11 and 8) with integrated arrangements of pistons (10) for transmitting of energy according to claim 1, characteristic of, that there in the cycle of operation for extraction of the optimum lot of energy by the arrangement has to be established of a higher sucking in pressure, by help of pressure, which has to be accumulated in belonging tanks (12) to the power machinery of waves, and where the accumulated pressure itself has to be made of the energy producing stroke of the cylinders (10 and 8).

3. Power machinery of waves, where the arrangement or the apparatus consist of one or more upright standing legs (11 and 8) with an integrated arrangement of piston (10) for transmitting of energy according to claim 1 and 2, characteristic of, that the rod of the piston (10 A) in the integrated arrangement of piston (10) is loosed placed on the bottom of the sea (17), where the cylinder (8) itself for this is mounted on a float (14), and where the rod of the piston (10A) in this combination work as counter hold leg, as there for the end of the rod of the piston against the bottom is mounted a movable and yielding pressure foot (1) or ski (1), which follow the surface of the bottom of the sea.

4. Power machinery of waves, where the arrangement or the apparatus consist of one or more upright standing legs (11 and 8) with an integrated arrangement of piston (10) for transmitting of energy according to above mentioned claims, characteristic of, that the upright standing leg (11 and 8) with integrated arrangements of pistons (10) is equipped with a glide—and coupling pipe (5) for coupling and guiding of the lower (11)—as the upper (8) part, for a continuos contact and a counter hold against the bottom (17), and by this a functional contact to this now active working arrangement of piston (10).

5. Power machinery of waves, where the arrangement or the apparatus consist of one or more upright standing legs (11 and 8) with an integrated arrangement of piston (10) for transmitting of energy according to above mentioned claims, characteristic of, that the underwater leg (11) more strategist places is done “flexible”, by pressure strong cardan parts or links (4), as an example into pressure strong embodiments, where they are made of strong material, and with powerful or heavy bearing bushes (4A), which have to be welded for a fixing.
